(19) United States
(12) Patent Application Publication
(10) Pub. No.: US 2007/0168398 A1
(43) Pub. Date: Jul. 19, 2007

(54) Permanent Storage Appliance

(75) Inventors: Alex Miroshnichenko, San Francisco, CA (US); Serge Pashenkov, Redwood City, CA (US); Kirk Dunn, Atherton, CA (US)

Correspondence Address: FENWICK & WEST LLP, SILICON VALLEY CENTER, 801 CALIFORNIA STREET, MOUNTAIN VIEW, CA, 94041, US

(73) Assignee: Powerfile, Inc., Santa Clara, CA (US)

(21) Appl. No.: 11/611,787

(22) Filed: Dec. 15, 2006

Related U.S. Application Data
(60) Provisional application No. 60/750,958, filed on Dec. 16, 2005.

(51) Int. Cl. G06F 17/30

(52) U.S. Cl. 707/200

(57) ABSTRACT

Embodiments provide permanent storage space for data available via network file access protocols. Client machines connect to the permanent storage appliance. The permanent storage appliance stages data to create an optical image according to a policy. The optical images are recorded on media and stored in a permanent media library that is accessible via the network.

### CROSS-REFERENCE TO RELATED APPLICATION(S)

This application claims priority under 35 U.S.C. § 119(e) to U.S. Provisional Patent Application No. 60/750,958 filed Dec. 16, 2005, which is hereby incorporated by reference in its entirety.

### BACKGROUND OF THE INVENTION

1. Field of the Invention

This invention pertains in general to data storage, and in particular to managing permanent storage of data.

2. Description of the Related Art

As increasing numbers of users make computers part of their everyday business and personal activities, the amount of data stored on computers has increased exponentially. Computer systems store vast music and video libraries, precious digital photographs, valuable business contacts, critical financial databases, and hoards of documents and other data.

Unfortunately, since the advent of computers, there has been an ever-present risk of losing data that is stored on them, whether through catastrophic loss or accidental loss. A virus attack, an equipment failure, or merely a few wrong keystrokes can immediately corrupt, destroy, erase, or overwrite that which was meant to be preserved. It is desirable to be able to store data in a safe, unalterable way to prevent these mishaps.

Because the consequences of such losses can be dire, methods of archiving data for long-term storage have been developed. Traditionally, there have been two choices for permanent storage: either data is kept online or it has been archived. Online data offers the advantages of rapid access in a searchable format. Archived data offers the advantages of being removable, providing longer-term storage, and freeing space on high-cost online storage subsystems, such as hard drives.

One alternative for storing data is copy data onto tape for archiving. Tape is not designed to provide easy, immediate access to information. It is typically written in a proprietary backup format and can only be searched sequentially. It is designed for the infrequent and unlikely retrieval of backup data when primary storage fails. It is designed for density, not access. Besides the inaccessibility of tape, there is the risk of storing important archives on a medium not intended for permanence. Tape is used for periodically overwriting files, not for preserving valuable fixed content in a permanently etched, unalterable form. Unlike certain types of optical media, tape is not native WORM compliant, and tape is susceptible to environmental influences such as magnetic interference. While tape may be adequate for backup data, it is not the ideal choice for archiving high-value fixed content.

Now that the pitfalls of tape for archiving are becoming more evident, some organizations are using disk as a storage medium for important archives. Disk offers the advantage of easy access to information as compared to tape. However, disk is not the ideal choice for long-term storage of fixed content. With an average shelf life of three years, disk does not offer permanence. Valuable records, archived for regulatory compliance purposes or historical analysis, should be stored on a medium with a far longer lifespan. Also, vital data should not be subjected to the risk of being overwritten or altered. In addition, while disks are declining in price, they are still exceedingly expensive. An organization may be able to cost-justify storing a few records on disk, but not a large and growing volume of archives.

What are needed are methods and systems for storing permanent copies of fixed content that provide rapid access and a long lifespan at a low cost.

### SUMMARY

Embodiments of the invention provide methods and systems for managing permanent storage of data. A permanent storage appliance provides data storage in a media library via network file access protocols and performs control and management of the media library. Client machines copy files of data from primary storage to a data cache within the permanent storage appliance. The permanent storage appliance creates a disc image of one or more cached files of data according to a policy. The disc image is recorded on media and stored in a permanent media library. A volume identification is used to uniquely identify the media among the media library, and the locations of the archival copy of the data within the data cache and the media library is mapped for each file. The permanent storage appliance has network attached storage characteristics which allow client machines access over the network to the files stored in the permanent storage appliance as easily as if they were stored on local disks. On request, the archival copy of a file can be accessed from the data cache if present, or from the media library.

In one embodiment, a long term archival of data is achieved using an optical subsystem. The optical subsystem can comprise a collection of optical discs and one or more disk drives organized in one or more DVD jukeboxes within an optical media library. Additional storage space or storage locations can be added by connecting additional media libraries.

The present invention has various embodiments, including as a computer implemented process, as computer apparatuses, and as computer program products that execute on general or special purpose processors. The features and advantages described in this summary and the following detailed description are not all-inclusive. Many additional features and advantages will be apparent to one of ordinary skill in the art in view of the drawings, detailed description, and claims.

### BRIEF DESCRIPTION OF THE DRAWINGS

FIG. 1 illustrates a generalized system architecture for a permanent storage appliance in accordance with one embodiment.

FIG. 2 illustrates another embodiment of a generalized system architecture for a permanent storage appliance.

FIG. 3 illustrates a functional block diagram of the operation of the permanent storage appliance in accordance with one embodiment.

FIG. 4 is a flowchart illustrating a method of permanently storing data in accordance with one embodiment.

FIG. 5 is a flowchart illustrating a method of accessing data stored in the permanent storage device in accordance with one embodiment.

The figures depict embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION OF THE EMBODIMENTS

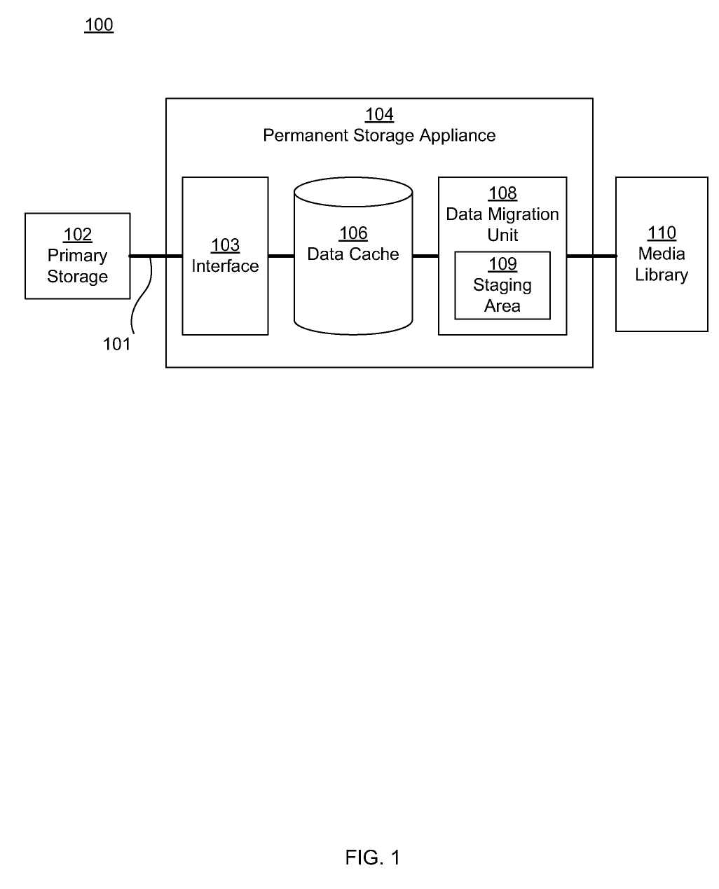

FIG. 1 illustrates a generalized system architecture 100 for a permanent storage appliance 104 in accordance with one embodiment. The system 100 includes at least one primary storage 102 connected via network 101 to a permanent storage appliance 104 which is connected to a media library or libraries 110. The figure does not show a number of conventional components (e.g. client computers, firewalls, routers, etc.) in order to not obscure the relevant details of the embodiment.

The primary storage 102 can be any data storage device, such as a networked hard disk, floppy disk, CD-ROM, tape drive, or memory card. It can be storage internal to a client computer on the network or a stand-alone storage device connected to the network. As shown in FIG. 1, the primary storage 102 is connected to the permanent storage appliance 104, for example, through a network connection 101. The network 101 can be any network, such as the Internet, a LAN, a MAN, a WAN, a wired or wireless network, a private network, or a virtual private network.

The permanent storage appliance 104 performs control and management of the media library or libraries 110, and allows access to the media library or libraries 110 through standard network file access protocols. The permanent storage appliance 104 includes interface 103, data cache 106 and data migration unit 108. The interface 103 allows access to archived files from the permanent storage appliance 104 over the network 101. In one embodiment, the Network File System (NFS) protocol is used to access files over the network. When NFS is used, the permanent storage appliance 104 can implement an NFS daemon. In one implementation, Network File System v3 and v4 are supported. Alternatively or additionally, the Common Internet File System (CIFS) or Server Message Block (SMB) protocol can be used to access files over the network. In one implementation, Samba is used for supporting CIFS protocol. Alternatively or additionally, other protocols can be used to access files over the network, and complementary interfaces 103 can be implemented as will be recognized by those of skill in the art.

In one embodiment, the data cache 106 file system is XFS™, a journaling file system created by Silicon Graphics Inc. for UNIX implementation. XFS™ implements the Data Management Application Program Interface (DMAPI) to support Hierarchical Storage Management (HSM), a data storage technique that allows an application to automatically move data between high-speed storage devices, such as hard disk drives to lower speed devices, such as optical discs and tape drives. The HSM system stores the bulk of the data on slower devices, and copies data to faster disk drives when needed. In one embodiment, the data cache 106 supports Redundant Array of Independent Disks (RAID) level 5. In other embodiments, other RAID levels can be supported and/or other redundancies of data can be implemented within the data cache 106 to improve confidence in the safety and integrity of data transferred to the permanent storage appliance 104. In one embodiment, the data cache 106 is disk-based for fast access to the most recently accessed data. Cached data can be replaced by more recently accessed data as necessary.

The data migration unit 108 within the permanent storage appliance 104 is used to copy data to and read data from the media library or libraries 110. The data migration unit 108 includes a staging area 109. The data migration unit 108 copies data from the data cache 106 to the media library 110 once a full media image is available. The data migration unit 108 uses the staging area 109 to store the media image temporarily until the data migration unit 108 has written the media image to the media library 110. The data migration unit 108 can also read media from the media library or libraries 110 and cache files in the data cache 106 before delivering them to the requesting client via the network 101.

Media library 110 can be, for example, a collection of optical disks and one or more disk drives organized in one or more DVD jukeboxes. In another embodiment, media library 110 can contain data stored on magnetic media or other data storage media known to those of skill in the art.

Optionally, permanent storage appliance 104 can include a graphical user interface (GUI) (not shown). The GUI allows a user to access optional and/or customizable features of the permanent storage appliance 104, and can allow an administrator to set policies for the operation of the permanent storage appliance 104. In one embodiment, the permanent storage appliance 104 includes a web server, such as an Apache web server that, in conjunction with the GUI, allows a user to access optional and/or customizable features of the permanent storage appliance 104. Alternatively or additionally to a GUI, the permanent storage appliance 104 can include a command line interface.

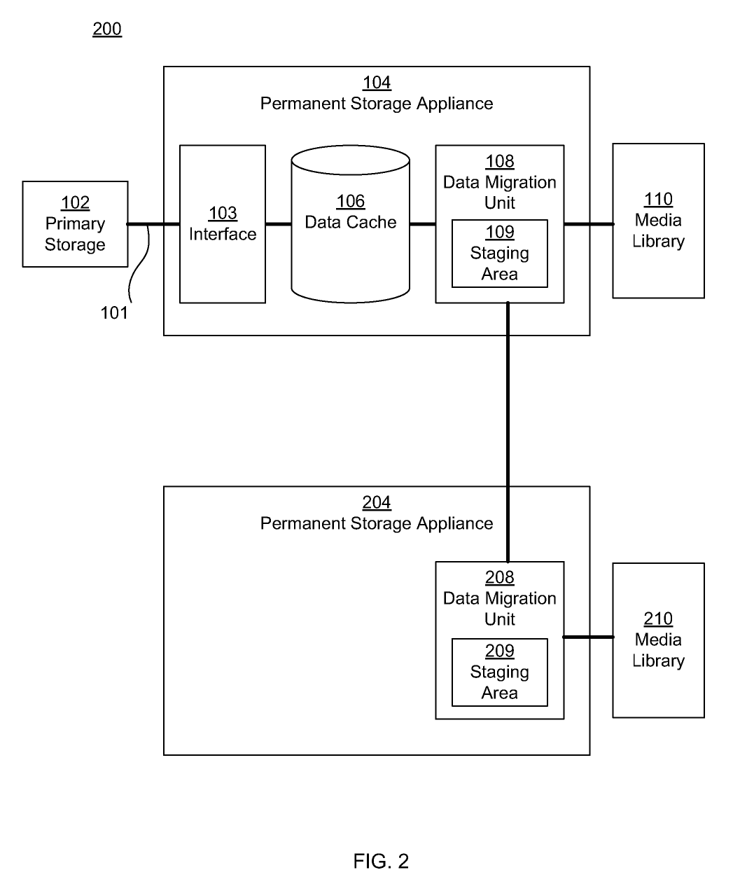

FIG. 2 illustrates another embodiment of a generalized system architecture 200 for a permanent storage appliance. In the example shown in FIG. 2, multiple data migration units 108, 208 have been communicatively coupled, with each data migration unit 108, 208 connected to at least one media library 110, 210. Although in this example, two data migration units 108, 208 have been daisy-chained together, in other embodiments, three or more data migration units can be connected, for example in series or parallel, or in any other configuration known to those of skill in the art. Each data migration unit 108, 208 can be connected to additional media libraries in series or parallel, or in any other configuration known to those of skill in the art, to provide additional locations for permanent storage. In one embodiment, the data migration units 108 and 208 are remotely located from each other. In another embodiment, data migration units 108 and 208 are in the same location. In yet another embodiment, media libraries 110 and 210 are in the same location. Alternatively, media libraries 110 and 210 may be in remote locations from each other and/or remote locations from data migration unit 108 and/or 208. In one variation, data migration unit 108 can write to and access data from media library 110, and data migration unit 208 can write to and access data from media library 210. This configuration can be advantageous, for example, in case of equipment failure or unavailability.

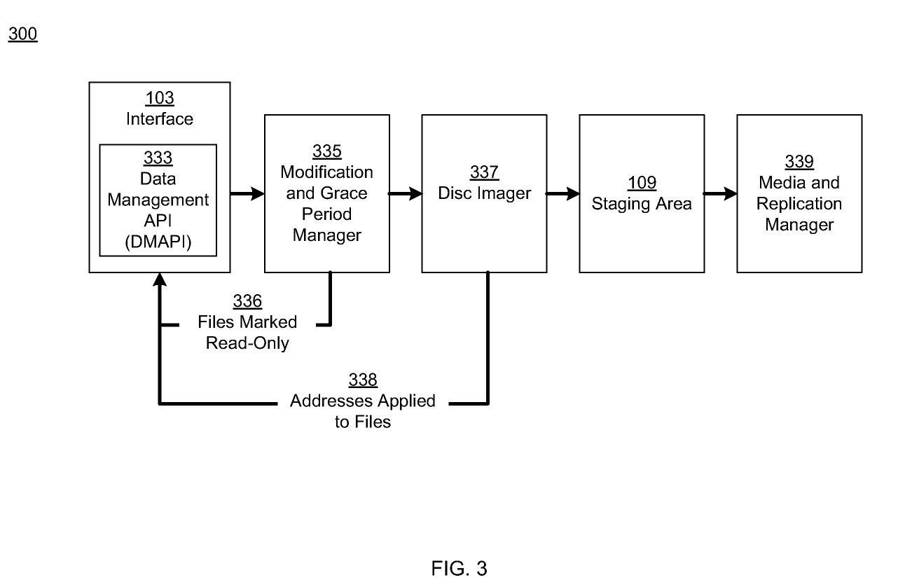

FIG. 3 illustrates a functional block diagram 300 of the operation of the permanent storage appliance in accordance with one embodiment. The interface 103 includes a Data Management API (DMAPI) 333 that provides a standard interface for monitoring information about files. Files of data are transferred from primary storage 102 through the DMAPI 302 to the Modification and Grace Period Manager 335. The Modification and Grace Period Manager 335 detects the presence of a new file and tracks the file modification history of the received files. From time to time, there may be delays in transfers of data from primary storage 102 to the data cache 106. In one embodiment, a grace period is established for designating the period during which changes to the data of one file, including additions and modifications will be accepted by the data cache 106 before the file is marked read-only, and further changes are prevented. Upon the expiration of the grace period, the file is eligible for archiving. The grace period can be used to determine when file changes are complete so that the file content that is archived is finished and consistent. In one embodiment, the grace period is customizable. For example, the grace period may be set for shorter than 30 seconds, for 3 minutes, for 30 minutes, or longer. Additionally or alternatively, other policies regarding when files are received for archiving and what type files are received can be established and implemented within the system. In one embodiment, the Modification and Grace Period Manager 335 tracks whether any modifications are made to a file within a grace period. If any modifications to the file are made within the grace period, then the grace period is reset and starts again. If the grace period expires without any modification to the file, then the Modification and Grace Period Manager 335 designates the file to be read-only. Notification that files are marked read-only 336 is returned through the DMAPI 333 in order to update the metadata associated with the file. Files that have been designated read-only are frozen as fixed content and are deemed ready for archiving into permanent storage in media library 110. After the file becomes read-only, any further write attempts can trigger an error message to be sent to the user.

The Disc Imager 337 converts files that have been deemed ready for archiving to a standard format and prepares a disc image from one or more files. In one embodiment, the Disc Imager 337 uses Universal Disc Format (UDF). The use of UDF or other standard format increases the compatibility of the discs from the media library 110 with other systems. The Disc Imager 337 can format files and arrange them within the disc image so as to increase or optimize disc space utilization. The Disc Imager 337 can also manage files so as to minimize fragmentation of files as well as to write to a disc a minimum number of times, both for efficiency and convenience.

Once the Disc Imager 337 has created the disc image comprised of one or more read-only files, the address of the permanent storage space for each file in the disc image is known. Thus, the volume identification and/or other address information for the copy of the data in permanent storage can be applied 338 to the files. Alternatively, the address information for the archival copy of the data can be applied to the files at any later point in the process, such as after the archival copy has been made, for example. The staging area 109 provides temporary storage of the disc image from the Disc Imager 337. Then, the Media and Replication Manager 339 writes the disc image from the staging area 109 to a disc in the media library 1110.

The Media and Replication Manager 339 manages disc images, the burn sequence, and performs verification to eliminate “marginal” burns. In one embodiment, the Media and Replication Manager 339 can perform verification in at least two ways. First, the Media and Replication Manager 339 can set verification settings on the optical drive so that the drive applies less effort to read data. Hence, marginally recorded areas can be identified by the failure of the drive to read them using these verification settings, whereas the same marginally recorded areas may have been readable using normal drive settings. If marginally recorded areas are detected, the disc can be discarded and a new disc is written. Secondly, when the data is read from the optical media, the Media and Replication Manager 339 can compare the reading with the original copy in the data cache 106 to identify any errors. If any errors are detected, the disc can be discarded an a new disc can be written. In one embodiment, the Media and Replication Manager 312 also creates a replica of the media image for disaster recovery. The replica can be stored in a remote location if desired for additional security against natural disasters.

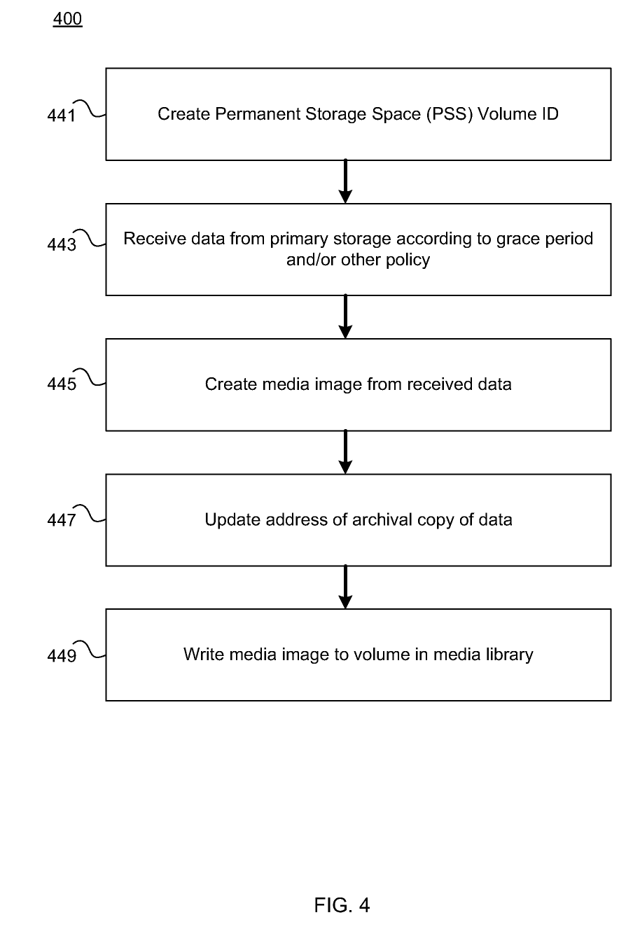

FIG. 4 is a flowchart illustrating a method 400 of permanently storing data in accordance with one embodiment. In step 441, a Permanent Storage Space (PSS) Volume ID is created. The volume ID is unique in time and space. The volume ID is used to uniquely identify the disc among the library of discs on which an archived file is stored. For example, sequential numbers, time stamps, or any other method of assigning unique IDs can be used to create the PSS Volume ID.

In step 443, data is received from primary storage 102 according to the established grace period. The data is temporarily stored in the data cache 106 as it is being received. In one embodiment, metadata of the file is stored in a data structure associated with the file. For example, the data structure can be an inode, or any other data structure for storing metadata or standard attributes such as file size, time stamps, permissions, and one or more block maps. Once a file is transferred to the data cache 106, the inode or other data structure corresponding to the file contains a block map pointing to the location on the data cache disk where the file is stored within the data cache 106. As discussed above, in one embodiment, a grace period is established for designating the period during which changes to the data of one file, including additions and modifications will be accepted by the data cache 106 before the file is marked read-only, and further changes are prevented. Upon the expiration of the grace period, the file is eligible for archiving. In one variation, multiple files are received into the data cache 106 from primary storage 102 for archiving within a single volume.

In step 445, a media image is created from the received data. The size of the media image should not exceed the size of the destination permanent storage space. In one embodiment, the media is DVD containing approximately 4 GB of data. In another embodiment, the media is a blu-ray disc™ containing much larger storage capacity, for example, in excess of 20 GB. Very large files may need to be distributed over more than one volume. To increase disc space utilization, multiple files can be arranged within one media image, for example by being placed end to end within the media image. Policies can be established as to how full a media image has to be before a volume is considered complete and is ready to be imaged onto a disc in the media library 110. For example, a policy can specify the minimum amount of data to image on a disc. As another example, a policy can specify the maximum number of files to image on one disc. Alternatively or additionally, policies can be established that deem a media image ready to be imaged based on time such as every hour, every night, every week, or the like; based on a triggering event such as a user request; or a user's action such as saving a file, closing a file, initiating a shut-down procedure, or any other user action.

In step 447, the inode, extended attributes associated with the file, or other data structure is updated to also include the address of the archival copy of the file within the media library 110 in addition to the physical address of the data blocks that comprise the file within the data cache 106. The address of the archival copy includes the volume ID and the specific location of the data within the volume. This dual map allows access to the file within the data cache 106 or the media library 110; the permanent storage appliance 104 will access the data from the fastest available location. Thus, the permanent storage appliance 104 accesses the file from the data cache 104 if it is available, but otherwise it can access the file from the media library 110. Within the example system of FIG. 2, the request for access may be passed from one data migration unit 108 to another 208 to find the requested volume. The method of accessing files from data cache 106 or the media library 110 can operate in a way that is invisible to the client machines, in one embodiment.

In step 449, the media image containing the archival copies of files is written to a volume in the media library 110. In one embodiment, the media image includes the created volume ID. Thus, access to the files within the volume is not dependent upon the volume remaining in the same relative location within the media library 110. In the event that volumes are removed or shuffled within the media library, the volumes still contain the identification of the volume for use by the permanent storage appliance 104 in accessing the archival copies of files. After the media image is recorded 449 to a volume in the media library 110, data in the data cache 106 or in the staging area 109 can be deleted to allow more space for new data as desired. Cache management algorithms known to those of skill in the art, such as first-in first-out (FIFO), can be employed to select files for deletion from the data cache 106 and the staging area 109. For example, frequency of retrieval and last modified data may be considered.

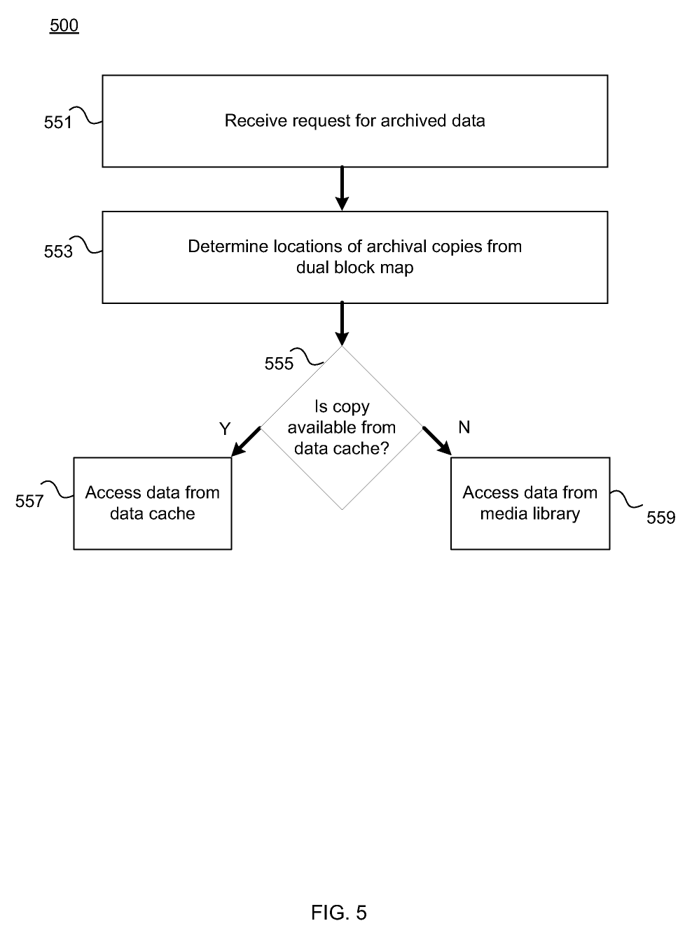

FIG. 5 is a flowchart illustrating a method 500 of accessing data stored in the permanent storage device 104 in accordance with one embodiment. In step 551, a request is received for archived data. In one embodiment, requests to access data can be received 551 and the permanent storage appliance 104 can provide access to data files in the data cache 106 or in the media library 110 through a standard network file access protocol.

In step 553, the location or locations of archival copies are determined from the dual block map. As discussed above, the inode or extended attributes associated with the file can contain metadata such as file size, time stamps, permissions, and one or more block maps that identify the storage location or locations of the file in the data cache 106 and/or on an optical volume in the media library 110. In one embodiment, the block map for the location in data cache 106 is blank if no corresponding file is available in the data cache 106. Similarly, the block map for the location in the media library 110 is blank if the data has not been imaged onto the optical media yet. Alternatively, the block map can contain another indicator that the data is not available within the data cache 106 or the media library 110.

In step 555, based on the information from the dual block map, the permanent storage appliance 104 can determine if a copy is available 555 from the data cache 106. If a copy is available from the data cache, the data is accessed 557 from the data cache 106. In one embodiment, the data from the data cache 557 can be accessed more quickly than data from the media library 110. Thus, for performance reasons, in this embodiment, it is faster to access data from the data cache 106 in cases when the data is available at that location. However, if the data is not available from the data cache 106, then the data is accessed 559 from the media library 110. Within the example architecture of FIG. 2, the request for access may be passed from one data migration unit 108 to another 208 to find the requested volume.

The above description is included to illustrate the operation of the embodiments and is not meant to limit the scope of the invention. From the above discussion, many variations will be apparent to one skilled in the relevant art that would yet be encompassed by the spirit and scope of the invention. Those of skill in the art will also appreciate that the invention may be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the features of the present invention in terms of methods and symbolic representations of operations on information. These descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “copying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of a method. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The methods and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the art, along with equivalent variations. In addition, the present invention is not described with reference to any particular programming language. It is appreciated that a variety of programming languages may be used to implement the teachings of the present invention as described herein, and any references to specific languages are provided for enablement and best mode of the present invention.

The present invention is well suited to a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention, which is set forth in the following claims.

What is claimed is:

1. A computer-implemented method of managing archived data, comprising:
receiving a file of data;
storing a file temporarily in a data cache at a location;
recording the location of the file in the data cache in a data structure associated with the file;
creating a media image from the file in the data cache;
writing the media image onto an optical disc having a unique identifier;
recording the unique identifier in the data structure associated with the file; and
storing the optical disc in a permanent media library.

2. The method of claim 1, further comprising accessing the file using a network file access protocol.

3. The method of claim 1, further comprising accessing the file using Network File System protocol.

4. The method of claim 1, further comprising accessing the file using Common Internet File System protocol.

5. The method of claim 1, further comprising accessing the file from the permanent media library using the unique identifier responsive to the file no longer being located in the data cache.

6. The method of claim 1, wherein the media image comprises a plurality of files.

7. The method of claim 1, further comprising determining a grace period for changes to the file has expired.

8. The method of claim 7, further comprising marking the file read-only.

9. The method of claim 1, wherein the data structure associated with the file is an inode.

10. The method of claim 1, wherein the optical disc comprises a DVD.

11. The method of claim 1, wherein the optical disc has a capacity in excess of 20 GB.

12. The method of claim 1, wherein creating a media image from the received data is performed in accordance with a policy.

13. The method of claim 12, wherein the policy specifies the minimum amount of data to image on a disc.

14. The method of claim 12, wherein the policy specifies the maximum number of files to image on one disc.

15. The method of claim 12, wherein the policy specifies the frequency of disc imaging.

16. The method of claim 12, wherein the policy specifies a user action that triggers creating a media image.

17. A computer-implemented method of accessing an archived file, comprising:
receiving a request for an archived file;
determining one or more locations of the archived file from a dual block map; and
responsive to the archived file not being located on a data cache disk; accessing the file from an optical media library.

18. The method of claim 17, wherein the dual block map is stored in an inode associated with the archived file.

19. The method of claim 17, wherein the dual block map is stored in an extended attribute associated with the file.

20. The method of claim 17, wherein the dual block map comprises a unique identifier of a volume within the media library.

21. The method of claim 17, wherein the dual block map comprises a location of the archived file on a data cache disk.

22. A permanent storage appliance, comprising:
a data cache for temporarily storing files to be archived;
a disc imager for creating disc images from the files in the data cache;
a replication manager for recording disc images onto discs for permanent storage in a media library; and
an interface for allowing access to the media library through a network file access protocol.
